(19) United States
(12) Patent Application Publication
(10) Pub. No.: US 2026/0130317 A1
(43) Pub. Date: May 14, 2026

(54) METHOD FOR PROVIDING CONTROL DATA FOR AN APPLICATION DEVICE

(71) Applicant: BASF SE, Ludwigshafen am Rhein (DE)

(72) Inventors: Gregor PASDA, Limburgerhof (DE); Manuel KNAUER, Limburgerhof (DE)

(21) Appl. No.: 19/111,640

(22) PCT Filed: Sep. 11, 2023
(86) PCT No.: PCT/EP2023/074898

§ 371 Date: Mar. 13, 2025

(30) Foreign Application Priority Data
Sep. 13, 2022 (EP) 22195419.1

(51) Int. Cl. A01C 21/00; C05C 9/00; C05G 3/90

(52) U.S. Cl. CPC A01C 21/007; A01C 21/005; C05C 9/00; C05G 3/90

(57) ABSTRACT

Computer-implemented method for providing control data for an application device for applying a fertilizer product on an agricultural field, comprising:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value;
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

### TECHNICAL FIELD

The present disclosure relates to a computer-implemented method for providing control data for an application device for applying a fertilizer product on an agricultural field, an application device for applying a fertilizer product on an agricultural field, a system and/or an apparatus for providing control data for an application device for applying a fertilizer product on an agricultural field, a use of different data in such a method and a respective computer program element.

### TECHNICAL BACKGROUND

The general background of this disclosure is the treatment of an agricultural field with a fertilizer product. Farmers apply fertilizer products, e.g. urea, ammonium nitrate, ammonium sulfate, calcium ammonium nitrate, manure, slurry etc. which contain nitrogen forms such as ammonium, nitrate, and/or organic nitrogen. Nitrogen is an essential element for plant growth, plant health and reproduction. About 5% of the plant available nitrogen in soils (ammonium and nitrate) originate from decomposition processes (mineralization) of organic nitrogen compounds such as humus, plant and animal residues and organic fertilizers. Approximately 5% derive from rainfall. On a global basis, the biggest part (90%), however, are supplied to the plant by organic and inorganic (so-called mineral) nitrogen fertilizers. The mainly used inorganic nitrogen fertilizers comprise urea and/or ammonium compounds or derivatives thereof, i.e. nearly 90% of the nitrogen fertilizers applied worldwide is in the urea and/or Nf form (cf. Subbarao et al., 2012, Advances in Agronomy, 114, 249-302). However, all nitrogen forms are transformed in the soil to other nitrogen forms, wherein during these transformation processes nitrogen losses in form of ammonia (NH₃), nitrous oxide (N₂O) and/or nitrate (NO₃) may occur. The extent of these nitrogen losses depend on different soil, weather and management factors. It is generally known that such nitrogen losses may be reduced by different means, for example by so-called nitrogen inhibitors, e.g. nitrification inhibitors, denitrification inhibitors, urease inhibitors or mineralization inhibitors. However, it is often difficult for a farmer to make an objective decision, if and how the respective means should be applied.

It has been found that a need exists to provide objective means to assess the impact of the use of a fertilizer comprising means for reducing nitrogen losses.

### SUMMARY OF THE INVENTION

An aspect of the present disclosure relates to a computer-implemented method for providing control data for an application device for applying a fertilizer product on an agricultural field, comprising:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value;
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

A further aspect of the present disclosure relates to an application device for applying a fertilizer product on an agricultural field, wherein the control data for the application device are provided by a computer-implemented method for providing control data for an application device as described in the present disclosure.

In other words, an application device for applying a fertilizer product on an agricultural field is provided. The application device is configured to use, particularly to be controlled by means of, control data for the application device, wherein the control data are control data provided by the method for providing control data for an application device as described in the present disclosure.

In yet other words, an application device for applying a fertilizer product on an agricultural field is provided. The application device is configured to use, particularly to be controlled by means of, control data for the application device, wherein the control data are control data provided by:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value;
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

In particular, the application device according to the present disclosure may be configured to operate in accordance with the control data. The control data may, for example, be configured for providing operation instructions for the operation of the application device. A further aspect of the present disclosure relates to a system for providing control data for an application device for applying a fertilizer product on an agricultural field, comprising:
a providing unit configured to provide field data of an agricultural field;
a further providing unit configured to provide first fertilizer product data, wherein the first fertilizer product data relates to a nitrogen fertilizer product comprising means for reducing nitrogen losses;
a further providing unit configured to provide second fertilizer product data, wherein the second fertilizer product data relates to a nitrogen fertilizer product not comprising means for reducing nitrogen losses;
a further providing unit configured to provide application rate data for the first fertilizer product and the second fertilizer product comprising application rates for applying the first fertilizer product and the second fertilizer product on the agricultural field base on the provided field data;
a further providing unit configured to provide an emission calculation model configured to calculate CO₂ equivalents for the first fertilizer product and the second fertilizer product based on the first fertilizer product data and the second fertilizer product data and the application rate data for the first fertilizer product and the second fertilizer product;
a further providing unit configured to provide CO₂ equivalent data for the first fertilizer product and the second fertilizer product utilizing the emission calculation model;
a further providing unit configured to provide a difference CO₂ equivalent value between an application of the first fertilizer product and the second fertilizer product based on the CO₂ equivalent data;
a further providing unit configured to provide a predetermined CO₂ equivalent saving value;
a further providing unit configured, in case the difference CO₂ equivalent value is above or equal to the CO₂ equivalent saving value, to provide control data for an application device for applying the first fertilizer product on the agricultural field; and in case the difference CO₂ equivalent value is below the CO₂ equivalent saving value to provide control data for an application device for applying the second fertilizer product on the agricultural field.

A further aspect of the present disclosure relates to an apparatus for providing control data for an application device for applying a fertilizer product on an agricultural field, the apparatus comprising: one or more computing nodes; and one or more computer-readable media having thereon computer-executable instructions that are structured such that, when executed by the one or more computing nodes, cause the apparatus to perform the following steps:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value;
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

A further aspect of the present disclosure relates to a use of field data, fertilizer product data, applications rate data and/or an emission calculation model in a computer-implemented method for providing control data for an application device as described in the present disclosure and/or in a system/apparatus for providing control data for an application device as described in the present disclosure.

A further aspect of the present disclosure relates to a computer program element with instructions, which, when executed on computing devices of a computing environment, is configured to carry out the steps of the computer-implemented method for providing control data for an application device, as described in the present disclosure, in a system/apparatus for providing control data for an application device as described in the present disclosure.

A further aspect of the present disclosure relates to a computer-implemented method for providing CO₂ equivalent data for fertilizer products for an agricultural field, comprising:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model.

A further aspect of the present disclosure relates to a system for providing CO₂ equivalent data for fertilizer products for an agricultural field, comprising:
a providing unit configured to provide field data of an agricultural field;
a further providing unit configured to provide first fertilizer product data, wherein the first fertilizer product data relates to a nitrogen fertilizer product comprising means for reducing nitrogen losses;
a further providing unit configured to provide second fertilizer product data, wherein the second fertilizer product data relates to a nitrogen fertilizer product not comprising means for reducing nitrogen losses;
a further providing unit configured to provide application rate data for the first fertilizer product and the second fertilizer product comprising application rates for applying the first fertilizer product and the second fertilizer product on the agricultural field based on the provided field data;
a further providing unit configured to provide an emission calculation model configured to calculate CO₂ equivalents for the first fertilizer product and the second fertilizer product based on the first fertilizer product data and the second fertilizer product data and the application rate data for the first fertilizer product and the second fertilizer product;
a further providing unit configured to provide CO₂ equivalent data for the first fertilizer product and the second fertilizer product utilizing the emission calculation model.

A further aspect of the present disclosure relates to an apparatus for providing CO₂ equivalent data for fertilizer products for an agricultural field, the apparatus comprising: one or more computing nodes; and one or more computer-readable media having thereon computer-executable instructions that are structured such that, when executed by the one or more computing nodes, cause the apparatus to perform the following steps:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model.

A further aspect of the present disclosure relates to a computer program element with instructions, which, when executed on computing devices of a computing environment, is configured to carry out the steps of the computer-implemented method for providing CO₂ equivalent data for fertilizer products for an agricultural field, as described in the present disclosure, in a system/apparatus for providing CO₂ equivalent data for fertilizer products for an agricultural field as described in the present disclosure.

A further aspect of the present disclosure relates to a computer computer-implemented method for providing CO₂ equivalent data for a fertilizer product for an agricultural field, comprising:
providing field data of an agricultural field;
providing fertilizer product data, wherein the fertilizer product data relates to a nitrogen fertilizer product comprising means for reducing nitrogen losses;
providing application rate data for the fertilizer product comprising application rates for applying the fertilizer product on the agricultural field based on the provided field data;
applying the fertilizer product on the agricultural field based on the application rate data;
providing an emission calculation model configured to calculate CO₂ equivalents for the fertilizer product based on the fertilizer product data and the application rate data for the fertilizer product;
providing CO₂ equivalent data for the fertilizer product utilizing the emission calculation model;
optionally, providing the CO₂ equivalent data to a measurement, reporting and verification (MRV) system.

A further aspect of the present disclosure relates to a use of CO₂ equivalent data provided by a computer-implemented method for providing CO₂ equivalent data for a fertilizer product for an agricultural field in a management system for producing a fertilizing product.

A further aspect of the present disclosure relates to a use of CO₂ equivalent data provided by a computer-implemented method for providing CO₂ equivalent data in a measurement, reporting and verification (MRV) system.

The embodiments described herein relate to the methods, the systems, the apparatuses, the application devices, the computer program elements lined out above and vice versa. Advantageously, the benefits provided by any of the embodiments and examples equally apply to all other embodiments and examples and vice versa.

As used herein “determining” also includes “estimating, calculating, initiating or causing to determine”, “generating” also includes “initiating or causing to generate”, and “providing” also includes “initiating or causing to determine, generate, select, send, query or receive”.

The methods, devices, systems, application devices, apparatuses, computer program elements, disclosed herein provide objective means to assess whether an agricultural field is to be fertilized with a fertilizer comprising means for reducing nitrogen losses.

Moreover, the present disclosure may provide CO₂ equivalent data for fertilizing an agricultural field by means of a fertilizer with and without means for reducing nitrogen losses. This may help a farmer to decide whether or not it is justified to fertilize an agricultural field with a fertilizer product comprising means for reducing nitrogen losses.

In addition, the present disclosure may provide CO₂ equivalent data for a fertilizer comprising means for reducing nitrogen losses, which has been applied on an agricultural field. This may help a farmer to decide whether or not, in future, it is justified to fertilize an agricultural field with a fertilizer product comprising means for reducing nitrogen losses.

It is an object of the present disclosure to provide objective means to assess whether an agricultural field is to be fertilized with a fertilizer comprising means for reducing nitrogen losses. Moreover, it is an object of the present disclosure to provide CO₂ equivalent data for fertilizing an agricultural field by means of a fertilizer with or without means for reducing nitrogen losses.

These and other objects, which become apparent upon reading the following description, are solved by the subject matters of the independent claims. The dependent claims refer to preferred embodiments of the invention.

The term agricultural field as used herein is to be understood broadly in the present case and presents any area, i.e. surface and subsurface, of a soil to be treated with a fertilizer product. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through field data referring to its geographical location or geo-referenced location data. A reference coordinate, a size and/or a shape may be used to further specify the agricultural field. The field data may be used to calculate the application rate/application amount for the agricultural field. The field data may further be used to specify in which climate region an agricultural field is located. The field data may further be used, in particular the geographical location of the agricultural field, for providing weather data, e.g. historical, actual and/or forecast weather data. Notably, the field data may further be used to provided soil parameter data, topography data, and any further data which may be used to fine-tune the emission calculation model.

The term control data as used herein is to be understood broadly in the present case and presents any data being configured to operate and control an application device. The control data are provided by a control unit and may be configured to control one or more technical means of the application device, e.g. the drive control but is not limited thereto.

The term application device used herein is to be understood broadly in the present case and represents any device being configured to fertilizers on the soil of an agricultural field. The application device may be configured to traverse the agricultural field. The application device may be a ground or an air vehicle, e.g. a tractor, a rail vehicle, a robot, an aircraft, an unmanned aerial vehicle (UAV), a drone, or the like. The application device can be an autonomous or a non-autonomous application device.

The term application system used herein is to be understood broadly in the present case and represent any holder or mounting of the application means, wherein the application system is mounted, coupled or arranged directly at the application device. Exemplary, the application system may be a sprayer boom, a fertilizer spreader boom but is not limited thereto. At least one, in particular a plurality of, application means are arranged at the application system.

The term fertilizer product as used herein is to be understood broadly and comprises any solid or liquid fertilizer products and combinations thereof. The term fertilizing/fertigation as used herein is to be understood broadly in the present case and presents any action to put, place or bring in fertilizers/a fertilizer product in a soil area of an agricultural field. A fertilizer is any material of natural or synthetic origin that is applied to soil or to plant tissues to supply plant nutrients.

The fertilizer product may contain urea, NO³⁻, NH₄⁺-ions, NH₃ and/or organic N or may be able produce NH₄⁺ ions or NH₃ in the soil by decomposition, e.g. hydrolysis. The term fertilizers may be understood as organic and/or chemical compounds applied to promote plant and fruit growth. Fertilizers are typically applied either through the soil (for uptake by plant roots), through soil substituents (also for uptake by plant roots), or by foliar feeding (for uptake through leaves). The term also includes mixtures of one or more different types of fertilizers as mentioned below.

The term fertilizers may be subdivided into several categories including: a) organic fertilizers (composed of decayed plant/animal matter), b) inorganic fertilizers (composed of chemicals and minerals) and c) urea-containing fertilizers. Organic fertilizers may include manure, e.g. liquid manure, semi-liquid manure, biogas manure, stable manure or straw manure, slurry, worm castings, peat, seaweed, compost, sewage, and guano. Green manure crops are also regularly grown to add nutrients (especially nitrogen) to the soil. Manufactured organic fertilizers include e.g. compost, blood meal, bone meal and seaweed extracts. Further examples are enzyme digested proteins, fish meal, and feather meal. The decomposing crop residue from prior years is another source of fertility. In addition, naturally occurring minerals such as mine rock phosphate, sulfate of potash and limestone are also considered inorganic fertilizers. Inorganic fertilizers are usually manufactured through chemical processes (e.g. N from such as the Haber-Bosch process), also using naturally occurring deposits, while chemically altering them (e.g. concentrated triple superphosphate). Naturally occurring inorganic fertilizers include Chilean sodium nitrate, mine rock phosphate, limestone, and raw potash fertilizers. The inorganic fertilizer may, in a specific embodiment, be a “NPK fertilizer”, “NP fertilizers” and “NK fertilizers”. NPK fertilizers are inorganic fertilizers formulated in appropriate concentrations and combinations comprising the three main nutrients nitrogen (N), phosphorus (P) and potassium (K) as well as typically S, Mg, Ca and trace elements. NP fertilizers are inorganic fertilizers formulated in appropriate concentrations and combinations comprising two main nutrients nitrogen (N) and phosphorus (P) as well as typically S, Mg, Ca and trace elements. NK fertilizers are inorganic fertilizers formulated in appropriate concentrations and combinations comprising the two main nutrients nitrogen (N) and potassium (K) as well as typically S, Mg, Ca and trace elements Other inorganic fertilizers may include ammonium nitrate, calcium ammonium nitrate, ammonium sulfate nitrate, ammonium sulfate or ammonium phosphate. Urea-containing fertilizer may, in specific embodiments, be urea, formaldehyde urea, urea ammonium nitrate (UAN) solution, urea sulfur, stabilized urea, urea based NPK-fertilizers, or urea ammonium sulfate. Also envisaged is the use of urea as fertilizer. In case urea-containing fertilizers or urea are used or provided, it is particularly preferred that urease inhibitors as defined herein above may be added or additionally be present or be used at the same time or in connection with the urea-containing fertilizers. Urea-containing fertilizers are hydrolyzed by microorganisms, thereby releasing ammonia that in turn forms ammonium-ions. Urea-containing fertilizers may thus be considered as a storage form of ammonium.

The fertilizer may be selected from solid or liquid ammonium- and/or nitrate-containing inorganic fertilizers, such as an NPK, NP and NK fertilizers, ammonium nitrate, calcium ammonium nitrate, ammonium sulfate nitrate, ammonium sulfate, calcium nitrate or ammonium phosphate; solid or liquid organic fertilizers, such as liquid manure, semi-liquid manure, stable manure, biogas manure and straw manure, worm castings, compost, seaweed or guano, or an urea-containing fertilizer such as urea, formaldehyde urea, urea ammonium nitrate (UAN) solution, urea sulfur, stabilized urea, urea based NPK-, NP- and NK-fertilizers, urea ammonium sulfate, or a mixture thereof. Preferably, the fertilizer contains NH₄⁺-ions; more preferably the fertilizer is selected from solid or liquid ammonium-containing inorganic fertilizers. Fertilizers may be provided in any suitable form, e.g. as powders, crystals, solid coated or uncoated prills or granules, in liquid or semi-liquid form, or as sprayable fertilizer. The fertilizer may be applied in the uses and methods of application via fertigation.

Coated fertilizers may be provided with a wide range of materials. Coatings may, for example, be applied to granular or prilled nitrogen (N) fertilizer or to multi-nutrient fertilizers. Typically, urea is used as base material for most coated fertilizers. Alternatively, ammonium, nitrate or NPK, NP and NK fertilizers are used is base material for coated fertilizers. The present disclosure, however, also envisages the use of other base materials for coated fertilizers, any one of the fertilizer materials defined herein. In certain embodiments, elemental sulfur may be used as fertilizer coating. The coating may be performed by spraying molten S over solid urea granules, followed by an application of sealant wax to close fissures in the coating. In a further embodiment, the S layer may be covered with a layer of organic polymers, preferably a thin layer of organic polymers. Further envisaged coated fertilizers may be provided by reacting resin-based polymers on the surface of the fertilizer granule. A further example of providing coated fertilizers includes the use of low permeability polyethylene polymers in combination with high permeability coatings. In specific embodiments, the composition and/or thickness of the fertilizer coating may be adjusted to control, for example, the nutrient release rate for specific applications. The duration of nutrient release from specific fertilizers may vary, e.g. from several weeks to many months. The presence of nitrogen inhibitors e.g. nitrification inhibitors, in a mixture with coated fertilizers may accordingly be adapted. It is, in particular, envisaged that the nutrient release involves or is accompanied by the release of a nitrogen inhibitor, e.g. a nitrification inhibitor, according to the present disclosure.

Coated fertilizers may be provided as controlled release fertilizers (CRFs). In specific embodiments these controlled release fertilizers are fully coated urea or N—P—K, N—P and N—K fertilizers, which are homogeneous, and which typically show a pre-defined longevity of release. In further embodiments, the CRFs may be provided as blended controlled release fertilizer products which may contain coated, uncoated and/or slow release components. In certain embodiments, these coated fertilizers may additionally comprise micronutrients. In specific embodiments these fertilizers may show a pre-defined longevity, e.g. in case of N—P—K, N—P and N—K fertilizers. Additional envisaged examples of CRFs include patterned release fertilizers. These fertilizers typically show a pre-defined release patterns (e.g. hi/standard/lo) and a pre-defined longevity. In exemplary embodiments, fully coated N—P—K, N—P and N—K Mg and micronutrients may be delivered in a patterned release manner. Also envisaged are double coating approaches or coated fertilizers based on a programmed release.

In further embodiments, the fertilizer mixture may be provided as, or may comprise or contain a slow release fertilizer (SRF) The fertilizer may, for example, be released over any suitable period of time, e.g. over a period of 1 to 5 months, preferably up to 3 months. Typical examples of ingredients of slow release fertilizers are IBDU (isobutylidenediurea), e.g. containing about 31-32% nitrogen, of which 90% is water insoluble; or UF, i.e. an urea-formaldehyde product which contains about 38% nitrogen of which about 70% may be provided as water insoluble nitrogen; or CDU (crotonylidene diurea) containing about 32% nitrogen; or MU (methylene urea) containing about 38 to 40% nitrogen, of which 25-60% is typically cold water insoluble nitrogen; or MDU (methylene diurea) containing about 40% nitrogen, of which less than 25% is cold water insoluble nitrogen; or MO (methylol urea) containing about 30% nitrogen, which may typically be used in solutions; or DMTU (diimethylene triurea) containing about 40% nitrogen, of which less than 25% is cold water insoluble nitrogen; or TMTU (tri methylene tetraurea), which may be provided as component of UF products; or TMPU (tri methylene pentaurea), which may also be provided as component of UF products; or UT (urea triazone solution) which typically contains about 28% nitrogen. The fertilizer mixture may also be long-term nitrogen-bearing fertilizer containing a mixture of acetylene diurea and at least one other organic nitrogen-bearing fertilizer selected from methylene urea, isobutylidene diurea, crotonylidene diurea, substituted triazones, triuret or mixtures thereof.

Any of the above mentioned fertilizers or fertilizer forms may suitably be combined. For instance, slow release fertilizers may be provided as coated fertilizers. They may also be combined with other fertilizers or fertilizer types. The same applies to the presence of a nitrogen inhibitor, e.g. a nitrification inhibitor, according to the present disclosure, which may be adapted to the form and chemical nature of the fertilizer and accordingly be provided such that its release accompanies the release of the fertilizer, e.g. is released at the same time or with the same frequency. The present disclosure further envisages fertilizer or fertilizer forms as defined herein in combination with nitrification inhibitors as defined herein, further in combination with urease inhibitors as defined herein and/or in combination with denitrification inhibitors and/or mineralization inhibitors. Such combinations may be provided as coated or uncoated forms and/or as slow or fast release forms. Preferred are combinations with slow release fertilizers including a coating. In further embodiments, also different release schemes are envisaged, e.g. a slower or a faster release.

The term fertigation/fertilizing as used herein refers to the application of fertilizers, optionally soil amendments, and optionally other water-soluble products together with water through an irrigation system to a plant or to the locus where a plant is growing or is intended to grow, or to a soil substituent as defined herein below. For example, liquid fertilizers or dissolved fertilizers may be provided via fertigation directly to a plant or a locus where a plant is growing or is intended to grow. Likewise, nitrogen inhibitors, e.g. nitrification inhibitors, according to the present disclosure, or in combination with additional nitrogen inhibitors, may be provided via fertigation to plants or to a locus where a plant is growing or is intended to grow. Fertilizers and nitrogen inhibitors according to the present disclosure, or in combination with additional nitrogen inhibitors, may be provided together, e.g. dissolved in the same charge or load of material (typically water) to be irrigated. In further embodiments, fertilizers and nitrogen inhibitors may be provided at different points in time. For example, the fertilizer may be fertigated first, followed by the nitrogen inhibitor, or preferably, the nitrogen inhibitor may be fertigated first, followed by the fertilizer. The time intervals for these activities follow the herein outlined time intervals for the application of fertilizers and nitrogen inhibitors. Also envisaged is a repeated fertigation of fertilizers and nitrogen inhibitors according to the present disclosure, either together or intermittently, e.g. every 2 hours, 6 hours, 12 hours, 24 hours, 2 days, 3 days, 4 days, 5 days, 6 days or more.

The term nitrogen inhibitor as used herein is to be understood broadly and comprises any chemical substance allowing to reduce greenhouse gas emissions by nitrogen losses after nitrogen fertilization of an agricultural field, e.g. nitrification inhibitors and/or urease inhibitors and/or denitrification inhibitors and/or mineralization inhibitors. They improve nitrogen use efficiency by reducing nitrogen losses in form of ammonia, nitrous oxide and nitrate. Nitrification inhibitors retard the natural transformation of ammonium into nitrate, by inhibiting for a certain period of time the activity of specific bacteria such as Nitrosomonas spp. The term nitrification as used herein is to be understood as the biological oxidation of ammonia (NH₃) or ammonium (NH₄+) with oxygen into nitrite (NO₂−) followed by the oxidation of these nitrites into nitrates (NO₃−) by microorganisms. Besides nitrate (NO₃−) nitrous oxide (N₂O) is also produced through nitrification. Nitrification is an important step in the nitrogen cycle in soil. The inhibition of nitrification may thus also reduce N₂O and/or NO₃ losses.

The first fertilizer product may comprise a nitrification inhibitor. Examples of nitrification inhibitors are: linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-2-thiodiazole (terrazole, etridiazole), sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl) acetamides such as N-((3(5)-methyl-1H-pyrazole-1-yl)methyl) acetamide, and N-(1H-pyrazolyl-methyl) formamides such as N-((3(5)-methyl-1H-pyrazole-1-yl)methyl formamide, N-(4-chloro-3(5)-methyl-pyrazole-1-ylmethyl)-formamide, N-(3 (5),4-dimethyl-pyrazole-1-ylmethyl)-formamide, neem, products based on ingredients of neem, cyan amide, melamine, zeolite powder, catechol, benzoquinone, sodium tetra borate, zinc sulfate, 2-(3,4-dimethyl-1H-pyrazol-1-yl) succinic acid, 3,4-dimethyl pyrazolium glycolate, 3,4-dimethyl pyrazolium mandelate, 1,2,4-triazole, 4-Chloro-3-methylpyrazole, a reaction adduct of dicyandiamide, urea and formaldehyde, or a triazonyl-formaldehyde-dicyandiamide adduct, 2-cyano-1-((4-oxo-1,3,5-triazinan-1-yl)methyl) guanidine, ((2-cyanoguanidino)methyl) urea, 2-cyano-1-((2-cyanoguanidino)methyl) guanidine, 4-amino-1,2,4-triazole hydrochloride (ATC), allylthiourea, chlorate salts, 1,2,3-triazole and its derivatives, derivatives of 5-amino-1,2,4-thiadiazole, heterocyclic compounds, methyl cinnamate, 1,9 Decanediol and combinations thereof.

The first fertilizer product may comprise a biological product for increasing the efficacy of nutrient/nitrogen utilization (so called biostimulants). Examples of biostimulants are: seaweed extracts (e.g., ascophyllum nodosum), bacterial extracts (e.g., extracts of one or more diazotrophs, phosphate-solubilizing microorgafjaponisms and/or biopesticides), fungal extracts, humic acids (e.g., potassium humate), fulvic acids, myo-inositol, glycine, lipo-chitooligosaccharides (LCO), chitooligosaccharides (CO), chitinous compounds, flavonoids, jasmonic acid or derivatives thereof (e.g., jasmonates), cytokinins, auxins, gibberellins, absiscic acid, ethylene, brassinosteroids, salicylates, macro- and micro-nutrients, linoleic acid or derivatives thereof, linolenic acid or derivatives thereof, karrikins, and/or beneficial microorganisms (e.g., Rhizobium spp., Bradyrhizobium spp., Sinorhizobium spp., Azorhizobium spp., Glomus spp., Gigaspora spp., Hymenoscyphous spp., Oidiodendron spp., Laccaria spp., Pisolithus spp., Rhizopogon spp., Scleroderma spp., Rhizoctonia spp., Acinetobacter spp., Arthrobacter spp., Arthrobotrys spp., Aspergillus spp., Azospirillum spp., Bacillus spp., Burkholderia spp., Candida spp., Chryseomonas spp., Enterobacter spp., Eupenicillium spp., Exiguobacterium spp., Klebsiella spp., Kluyvera spp., Microbacterium spp., Mucor spp., Paecilomyces spp., Paenibacillus spp., Penicillium spp., Pseudomonas spp., Serratia spp., Stenotrophomonas spp., Streptomyces spp., Streptosporangium spp., Swaminathania spp., Thiobacillus spp., Torulospora spp., Vibrio spp., Xanthobacter spp., Xanthomonas spp., etc.), and any combinations thereof.

The first fertilizer product may comprise a urease inhibitor. Examples of urease inhibitors are: N-(n-butyl) thiophosphoric acid triamide (NBPT, Agrotain), N-(n-propyl) thiophosphoric acid triamide (NPPT), 2-nitrophenyl phosphoric triamide (2-NPT), further NXPTs known to the skilled person, phenylphosphorodiamidate (PPD/PPDA), hydroquinone, ammonium thiosulfate, neem, mixtures of NBPT and Duromide (Anvol), and mixtures of NBPT and NPPT (see e.g. U.S. Pat. No. 8,075,659). Such mixtures of NBPT and NPPT may comprise NBPT in amounts of from 40 to 95% wt.-% and preferably of 60 to 80% wt.-% based on the total amount of active substances. Such mixtures are marketed as LIMUS, which is a composition comprising about 16.9 wt.-% NBPT and about 5.6 wt.-% NPPT and about 77.5 wt.-% of other ingredients including solvents and adjuvants.

Examples of denitrification inhibitor are: pyraclostrobin, azoxystrobin, dimoxystrobin, enestroburin, fluoxastrobin, kresoxim-methyl, metominostrobin, orysastrobin, picoxystrobin, trifloxystrobin, pyrametostrobin, pyraoxystrobin, coumoxystrobin, coumethoxystrobin, fenaminostrobin (=diclofenoxystrobin), flufenoxystrobin, 2-(2-(6-(3-chloro-2-methyl-phenoxy)-5-fluoro-pyrimidin-4-yloxy)-phenyl)-2-methoxyimino-N-methyl-acetamide, 3-methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)ethyl]benzyl) carbamate and 2-(2-(3-(2,6-dichlorophenyl)-1-methyl-allylideneaminooxymethyl)-phenyl)-2-methoxyimino-N methyl-acetamide.

The (relative) global warming potential (GWP) or CO₂ equivalent of a chemical compound is a measure of its relative contribution to the greenhouse effect, i.e. its average warming effect on the Earth's atmosphere over a certain period of time (usually 100 years). It thus indicates how much a given mass of a greenhouse gas contributes to global warming compared to the same mass of CO₂.

The term providing as used herein is to be understood broadly in the present case and represents any providing, receiving, querying, measuring, calculating, determining, transmitting of data, but is not limited thereto. Data may be provided by a user via a user interface, depicted/shown to a user by a display, and/or received from other devices, queried from other devices, measured other devices, calculated by other device, determined by other devices and/or transmitted by other devices.

The term data as used herein is to be understood broadly in the present case and represents any kind of data. Data may be single numbers/numerical values, a plurality of a numbers/numerical values, a plurality of a numbers/numerical values being arranged within a list, 2 dimensional maps or 3 dimensional maps, but are not limited thereto.

In an embodiment of the method for providing control data for an application device for applying a fertilizer product on an agricultural field and/or the method for providing CO₂ equivalent data for fertilizer products for an agricultural field, the means for reducing nitrogen losses are provided by a nitrogen inhibitor, a biological product increasing the efficacy of nitrogen utilization, a slow-release fertilizer and/or a controlled release fertilizer.

In an embodiment of the method for providing control data for an application device for applying a fertilizer product on an agricultural field and/or the method for providing CO₂ equivalent data for fertilizer products for an agricultural field, the first and/or the second fertilizer product is a NPK, NP and NK fertilizer, an ammonium nitrate fertilizer, a calcium ammonium nitrate fertilizer, an ammonium sulfate nitrate fertilizer, an ammonium sulfate fertilizer, an ammonium phosphate fertilizer, a urea fertilizer, a formaldehyde urea fertilizer, a urea ammonium nitrate (UAN) solution fertilizer, a urea sulfur fertilizer, a slow-release fertilizer and/or a controlled-release.

In an embodiment of the method for providing control data for an application device for applying a fertilizer product on an agricultural field and/or the method for providing CO₂ equivalent data for fertilizer products for an agricultural field, the nitrogen inhibitor is a urease inhibitor or a nitrification inhibitor or a denitrification inhibitor or a mineralization inhibitor or a combination thereof.

In an embodiment of the method for providing control data for an application device for applying a fertilizer product on an agricultural field and/or the method for providing CO₂ equivalent data for fertilizer products for an agricultural field, the nitrification inhibitor is selected from linoleic acid, alpha-linolenic acid, methyl p-coumarate, methyl ferulate, methyl 3-(4-hydroxyphenyl) propionate (MHPP), Karanjin, brachialacton, p-benzoquinone sorgoleone, 2-chloro-6-(trichloromethyl)-pyridine (nitrapyrin or N-serve), dicyandiamide (DCD, DIDIN), 3,4-dimethyl pyrazole phosphate (DMPP, ENTEC), 4-amino-1,2,4-triazole hydrochloride (ATC), 1-amido-2-thiourea (ASU), 2-amino-4-chloro-6-methylpyrimidine (AM), 2-mercapto-benzothiazole (MBT), 5-ethoxy-3-trichloromethyl-1,2,4-thiodiazole (terrazole, etridiazole), 2-sulfanilamidothiazole (ST), ammoniumthiosulfate (ATU), 3-methylpyrazol (3-MP), 3,5-dimethylpyrazole (DMP), 1,2,4-triazol thiourea (TU), N-(1H-pyrazolyl-methyl) acetamides such as N-((3(5)-methyl-1H-pyrazole-1-yl)methyl) acetamide, and N-(1H-pyrazolyl-methyl) formamides such as N-((3(5)-methyl-1H-pyrazole-1-yl)methyl formamide, N-(4-chloro-3(5)-methyl-pyrazole-1-ylmethyl)-formamide, N-(3(5),4-dimethyl-pyrazole-1-ylmethyl)-formamide, neem, products based on ingredients of neem, cyan amide, melamine, zeolite powder, catechol, benzoquinone, sodium terta board, zinc sulfate, and
a) 2-(3,4-dimethyl-1H-pyrazol-1-yl) succinic acid and/or 2-(4,5-dimethyl-1H-pyrazol-1-yl) succinic acid, and/or a derivative thereof, and/or a salt thereof;
b) glycolic acid addition salt of 3,4-dimethyl pyrazole (3,4-dimethyl pyrazolium glycolate), and/or an isomer thereof, and/or a derivative thereof;
c) citric acid addition salt of 3,4-dimethyl pyrazole (3,4-dimethyl pyrazolium citrate), and/or an isomer thereof, and/or a derivative thereof;
d) lactic acid addition salt of 3,4-dimethyl pyrazole (3,4-dimethyl pyrazolium lactate), and/or an isomer thereof, and/or a derivative thereof;
e) mandelic acid addition salt of 3,4-dimethyl pyrazole (3,4-dimethyl pyrazolium mandelate), and/or an isomer thereof, and/or a derivative thereof;
f) 1,2,4-triazole, and/or a derivative thereof, and/or a salt thereof;
g) 4-Chloro-3-methylpyrazole, and/or an isomer thereof, and/or a derivative thereof, and/or a salt thereof;
h) a reaction adduct of dicyandiamide, urea and formaldehyde (Centuro), or a triazonyl-formaldehyde-dicyandiamide adduct;
i) 2-cyano-1-((4-oxo-1,3,5-triazinan-1-yl)methyl) guanidine,
j) 1-((2-cyanoguanidino)methyl) urea;
k) 2-cyano-1-((2-cyanoguanidino)methyl) guanidine;
l) allylthiourea; and/or
m) chlorate salts.

In an embodiment of the method for providing control data for an application device for applying a fertilizer product on an agricultural field and/or the method for providing CO₂ equivalent data for fertilizer products for an agricultural field, the urease inhibitor is selected from N-(n-butyl) thiophosphoric acid triamide (NBPT, Agrotain), a reaction adduct of NBPT, urea and formaldehyde (Duromide), mixtures of NBPT and Duromide (Anvol), N-(n-propyl) thiophosphoric acid triamide (NPPT), 2-nitrophenyl phosphoric triamide (2-NPT), phenylphosphorodiamidate (PPD/PPDA), hydroquinone, ammonium thiosulfate, neem and mixtures of NBPT and NPPT.

In an embodiment of the method for providing control data for an application device for applying a fertilizer product on an agricultural field and/or the method for providing CO₂ equivalent data for fertilizer products for an agricultural field, the application rate data comprises an application amount of the fertilizer products as a unit of weight provided for treating the agricultural field with the fertilizer products. In this respect, the field data may be used for summing up the application rate deriving the amount of fertilizer products used for fertilizing the agricultural field. In an example, the application rate is provided as weight unit per area unit and the summed application amount may be received by multiplying the application rate with the area of the agricultural field.

In an embodiment of the method for providing control data for an application device for applying a fertilizer product on an agricultural field and/or the method for providing CO₂ equivalent data for fertilizer products for an agricultural field, the application rates for the first fertilizer product are lower than the application rates for the second fertilizer product based on the reduction of nitrogen losses due to the means for reducing the nitrogen losses.

In an embodiment of the method for providing control data for an application device for applying a fertilizer product on an agricultural field and/or the method for providing CO₂ equivalent data for fertilizer products for an agricultural field, the emission calculation model is configured to calculate CO₂ equivalents based on the nitrogen content of the fertilizer product and the application rate of the fertilizer products.

In an embodiment of the method for providing control data for an application device for applying a fertilizer product on an agricultural field and/or the method for providing CO₂ equivalent data for fertilizer products for an agricultural field, the emission calculation model is configured to calculate direct N₂O emissions, indirect N₂O emissions due to NO₃ leaching/losses and/or indirect N₂O emissions due to NH₃ losses caused by the applied nitrogen amount of fertilizers with and without nitrogen inhibitor.

In an embodiment of the method for providing control data for an application device for applying a fertilizer product on an agricultural field and/or the method for providing CO₂ equivalent data for fertilizer products for an agricultural field, the emission calculation model is configured to calculate direct N₂O emissions of the first fertilizer product based on a N₂O (emission) reduction factor compared to N₂O emissions of the second fertilizer product.

In an embodiment of the method for providing control data for an application device for applying a fertilizer product on an agricultural field and/or the method for providing CO₂ equivalent data for fertilizer products for an agricultural field, for liquid or solid fertilizers or combinations thereof different N₂O reduction factors are provided.

In an embodiment of the method for providing control data for an application device for applying a fertilizer product on an agricultural field and/or the method for providing CO₂ equivalent data for fertilizer products for an agricultural field, for different climate conditions and/or different weather conditions and/or different soil conditions/parameters and/or farm management factors different N₂O reduction factors are provided.

If a different N₂O reduction factor is provided for different climate conditions, information in which climate region an agricultural field is located may be provided to the calculation model, e.g. by means of the field data. In an example, respective climate maps may be provided. If a different N₂O reduction factor is provided for different weather conditions, respective weather data may also be provided to the calculation model.

If a different N₂O reduction factor is provided for different soil conditions/parameters, respective soil data may also be provided to the calculation model. The weather data and/or the soil data may also be derived from field data for the agricultural field of question. If a different N₂O reduction factor is provided for different farm management factors, respective farm management data may also be provided to the calculation model.

In an embodiment of the method for providing control data for an application device for applying a fertilizer product on an agricultural field and/or the method for providing CO₂ equivalent data for fertilizer products for an agricultural field, the emission calculation model is configured to calculate indirect N₂O emissions due to NO₃ leaching of the first fertilizer product based on a NO₃ (emission) reduction factor compared to NO₃ emissions of the second fertilizer product.

In an embodiment of the method for providing control data for an application device for applying a fertilizer product on an agricultural field and/or the method for providing CO₂ equivalent data for fertilizer products for an agricultural field, for liquid or solid fertilizers or combinations thereof different NO₃ reduction factors are provided.

In an embodiment of the method for providing control data for an application device for applying a fertilizer product on an agricultural field and/or the method for providing CO₂ equivalent data for fertilizer products for an agricultural field, for different climate conditions and/or different weather conditions, and/or soil conditions/parameters, and/or farm management factors different NO₃ reduction factors are provided. If a different NO₃ reduction factor is provided for different climate conditions, information in which climate region an agricultural field is located may be provided to the calculation model, e.g. by means of the field data. In an example, respective climate maps may be provided. If a different NO₃ reduction factor is provided for different weather conditions, respective weather data may also be provided to the calculation model. If a different NO₃ reduction factor is provided for different soil conditions/parameters, respective soil data may also be provided to the calculation model. The weather data and/or the soil data may also be derived from field data for the agricultural field of question. If a different NO₃ reduction factor is provided for different farm management factors, respective farm management data may also be provided to the calculation model.

In an embodiment of the method for providing control data for an application device for applying a fertilizer product on an agricultural field and/or the method for providing CO₂ equivalent data for fertilizer products for an agricultural field, the emission calculation model is configured to calculate indirect N₂O emissions due to NH₃ losses caused by the nitrification inhibitor based on a NH₃ increase factor compared to NH₃ emissions of the second fertilizer product.

In an embodiment of the method for providing control data for an application device for applying a fertilizer product on an agricultural field and/or the method for providing CO₂ equivalent data for fertilizer products for an agricultural field, different NH₃ increase factors are provided for urea, ammonium-based, nitrate-based and/or ammonium-nitrate-based fertilizer products as well as organic fertilizers like manure.

In an embodiment of the method for providing control data for an application device for applying a fertilizer product on an agricultural field and/or the method for providing CO₂ equivalent data for fertilizer products for an agricultural field, for different climate conditions and/or different weather conditions, and/or soil conditions/parameters, and/or farm management factors different NH₃ increase factors are provided. If a different NH₃ increase factor is provided for different climate conditions, information in which climate region an agricultural field is located may be provided to the calculation model, e.g. by means of the field data. In an example, respective climate maps may be provided. If a different NH₃ increase factor is provided for different weather conditions, respective weather data may also be provided to the calculation model. If a different NH₃ increase factor is provided for different soil conditions/parameters, respective soil data may also be provided to the calculation model. The weather data and/or the soil data may also be derived from field data for the agricultural field of question. If a different NH₃ increase factor is provided for different farm management factors, respective farm management data may also be provided to the calculation model.

In an embodiment of the method for providing control data for an application device for applying a fertilizer product on an agricultural field and/or the method for providing CO₂ equivalent data for fertilizer products for an agricultural field, the emission calculation model is configured to calculate indirect N₂O emissions due to reduction of NH₃ losses caused by the urease inhibitor based on a NH₃ reduction factor compared to NH₃ emissions of the second fertilizer product.

In an embodiment of the method for providing control data for an application device for applying a fertilizer product on an agricultural field and/or the method for providing CO₂ equivalent data for fertilizer products for an agricultural field, different NH₃ reduction factors are provided for urea, ammonium-based, nitrate-based and/or ammonium-nitrate-based fertilizer products.

In an embodiment of the method for providing control data for an application device for applying a fertilizer product on an agricultural field and/or the method for providing CO₂ equivalent data for fertilizer products for an agricultural field, for different climate conditions, and/or soil conditions/parameters, and/or farm management factors different NH₃ reduction factors are provided. If a different NH₃ reduction factor is provided for different climate conditions, information in which climate region an agricultural field is located may be provided to the calculation model, e.g. by means of the field data. In an example, respective climate maps may be provided. If a different NH₃ reduction factor is provided for different weather conditions, respective weather data may also be provided to the calculation model. If a different NH₃ reduction factor is provided for different soil conditions/parameters, respective soil data may also be provided to the calculation model. The weather data and/or the soil data may also be derived from field data for the agricultural field of question. If a different NH₃ reduction factor is provided for different farm management factors, respective farm management data may also be provided to the calculation model.

In the present disclosure, a N₂O emission reduction factor of a nitrification inhibitor between −31 to −44% (depending on different growing conditions) is applied, wherein an average N₂O emission reduction factor of minus 38% is applied.

In the present disclosure, a N₂O emission reduction factor of a urease inhibitor between −3 to −39% (depending on different growing conditions) is applied, wherein an average N₂O emission reduction factor of minus 25% is applied.

In the present disclosure, a NO₃ emission reduction factor between −7 to −29% for nitrification inhibitor (dependent on different growing conditions) is applied, wherein an average NO₃ emission reduction factor of minus 18% is applied.

In the present disclosure, a N₂O emission factor for N leaching between 0 to 2% is applied (depending on different growing conditions), wherein an average of 1.1% is applied.

In the present disclosure, a NH₃ emission increase factor for a nitrification inhibitor on urea between +30 to +65% (depending on different growing conditions) is applied, wherein an average NH₃ emission increase factor of 47% is applied.

In the present disclosure, a NH₃ emission reduction factor for a urease inhibitor on urea between 0 to −94% (depending on different growing conditions) is applied, wherein an average of −70% is applied.

Notably, the above mentioned reduction and increase factors are in particular dependent on the growing conditions. Moreover, these factors may be further dependent on other various factors, like climate, weather, soil property/density, etc. In an example, the above mentioned factors are at least partially individualized for an agricultural field by means of trials and test series.

### BRIEF DESCRIPTION OF THE DRAWINGS

In the following, the present disclosure is further described with reference to the enclosed figures:

FIG. 1 illustrate example embodiments of a centralized and a decentralized computing environment with computing nodes;

FIG. 2 illustrate example embodiments of a centralized and a decentralized computing environment with computing nodes;

FIG. 3 illustrate an example embodiment of a distributed computing environment;

FIG. 4 schematically illustrates N loss reactions that may occur in the soil;

FIG. 5 schematically illustrates the effects of nitrogen inhibitors;

FIG. 6 illustrates a flow diagram of a method for providing control data for an application device for applying a fertilizer product on an agricultural field;

FIG. 7 illustrates a system for providing control data for an application device for applying a fertilizer product on an agricultural field; and

FIG. 8 illustrates exemplarily the different possibilities to receive and process field data.

### DETAILED DESCRIPTION OF EMBODIMENT

The following embodiments are mere examples for implementing the method, the system, the apparatus, or application device disclosed herein and shall not be considered limiting.

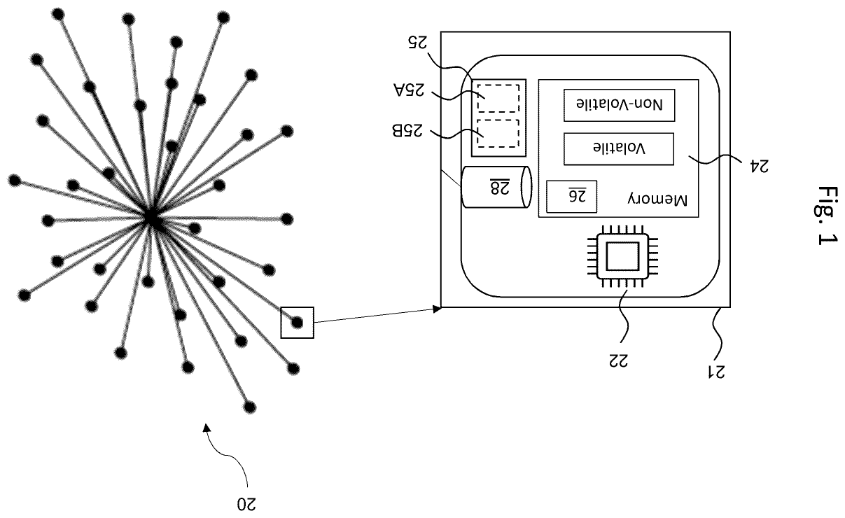

FIGS. 1 to 3 illustrate different computing environments, central, decentral and distributed. The methods, apparatuses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more sustainable way by using digital ecosystems. Providing, determining or processing of data may be realized by different computing nodes, which may be implemented in a centralized, a decentralized or a distributed computing environment.

FIG. 1 illustrates an example embodiment of a centralized computing system 20 comprising a central computing node 21 (filled circle in the middle) and several peripheral computing nodes 21.1 to 21.n (denoted as filled circles in the periphery). The term “computing system” is defined herein broadly as including one or more computing nodes, a system of nodes or combinations thereof. The term “computing node” is defined herein broadly and may refer to any device or system that includes at least one physical and tangible processor, and/or a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 21.1 to 21.n may be connected to one central computing system (or server). In another example, the peripheral computing nodes 21.1 to 21.n may be attached to the central computing node via e.g. a terminal server (not shown). The majority of functions may be carried out by, or obtained from the central computing node (also called remote centralized location). One peripheral computing node 21.n has been expanded to provide an overview of the components present in the peripheral computing node. The central computing node 21 may comprise the same components as described in relation to the peripheral computing node 21.n.

Each computing node 21, 21.1 to 21.n may include at least one hardware processor 22 and memory 24. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 24 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 21, 21.1 to 21.n may include multiple structures 26 often referred to as an “executable component, executable instructions, computer-executable instructions or instructions”. For instance, memory 24 of the computing nodes 21, 21.1 to 21.n may be illustrated as including executable component 26. The term “executable component” or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 21, 21.1 to 21.n, whether such an executable component exists in the heap of a computing node 21, 21.1 to 21.n, or whether the executable component exists on computer-readable storage media. In such a case, one of ordinary skill in the art will recognize that the structure of the executable component exists on a computer-readable medium such that, when interpreted by one or more processors of a computing node 21, 21.1 to 21.n (e.g., by a processor thread), the computing node 21, 21.1 to 21n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 22 of each computing node 21, 21.1 to 21.n may direct the operation of each computing node 21, 21.1 to 21.n in response to having executed computer-executable instructions that constitute an executable component. For example, such computer-executable instructions may be embodied on one or more computer-readable media that form a computer program product. The computer-executable instructions may be stored in the memory 24 of each computing node 21, 21.1 to 21.n. Computer-executable instructions comprise, for example, instructions and data which, when executed at a processor 21, cause a general purpose computing node 21, 21.1 to 21.n, special purpose computing node 21, 21.1 to 21.n, or special purpose processing device to perform a certain function or group of functions. Alternatively or in addition, the computer-executable instructions may configure the computing node 21, 21.1 to 21.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 21, 21.1 to 21.n may contain communication channels 28 that allow each computing node 21.1 to 21.n to communicate with the central computing node 21, for example, a network (depicted as solid line between peripheral computing nodes and the central computing node in FIG. 1). A “network” may be defined as one or more data links that enable the transport of electronic data between computing nodes 21, 21.1 to 21.n and/or modules and/or other electronic devices. When information is transferred or provided over a network or another communications connection (either hardwired, wireless, or a combination of hardwired or wireless) to a computing node 21, 21.1 to 21.n, the computing node 21, 21.1 to 21.n properly views the connection as a transmission medium. Transmission media can include a network and/or data links which can be used to carry desired program code means in the form of computer-executable instructions or data structures and which can be accessed by a general-purpose or special-purpose computing nodes 21, 21.1 to 21.n. Combinations of the above may also be included within the scope of computer-readable media.

The computing node(s) 21, 21.1 to 21.n may further comprise a user interface system 25 for use in interfacing with a user. The user interface system 25 may include output mechanisms 25A as well as input mechanisms 25B. The principles described herein are not limited to the precise output mechanisms 25A or input mechanisms 25B as such will depend on the nature of the device. However, output mechanisms 25A might include, for instance, displays, speakers, displays, tactile output, holograms and so forth. Examples of input mechanisms 25B might include, for instance, microphones, touchscreens, holograms, cameras, keyboards, mouse or other pointer input, sensors of any type, and so forth.

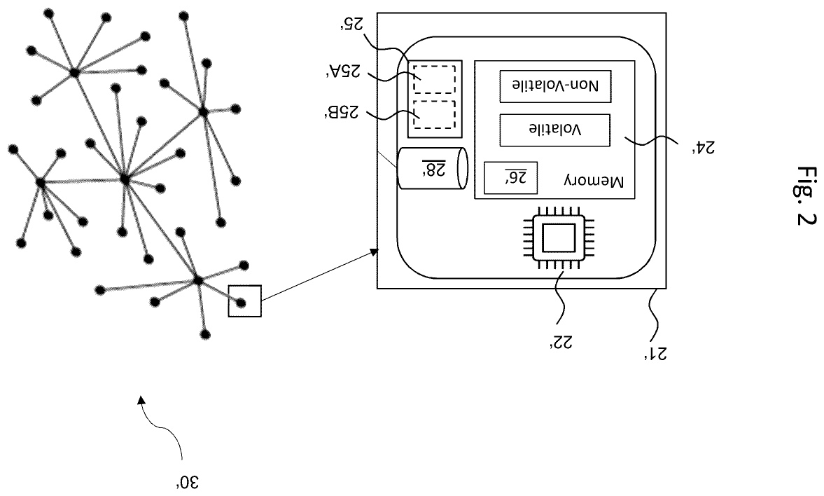

FIG. 2 illustrates an example embodiment of a decentralized computing environment 30 with several computing nodes 21.1 to 21.n denoted as filled circles. In contrast to the centralized computing environment 20 illustrated in FIG. 1, the computing nodes 21.1 to 21.n of the decentralized computing environment are not connected to a central computing node 21 and are thus not under control of a central computing node. Instead, resources, both hardware and software, may be allocated to each individual computing node 21.1 to 21.n (local or remote computing system) and data may be distributed among various computing nodes 21.1 to 21.n to perform the tasks. Thus, in a decentral system environment, program modules may be located in both local and remote memory storage devices. One computing node 21 has been expanded to provide an overview of the components present in the computing node 21. In this example, the computing node 21 comprises the same components as described in relation to FIG. 1.

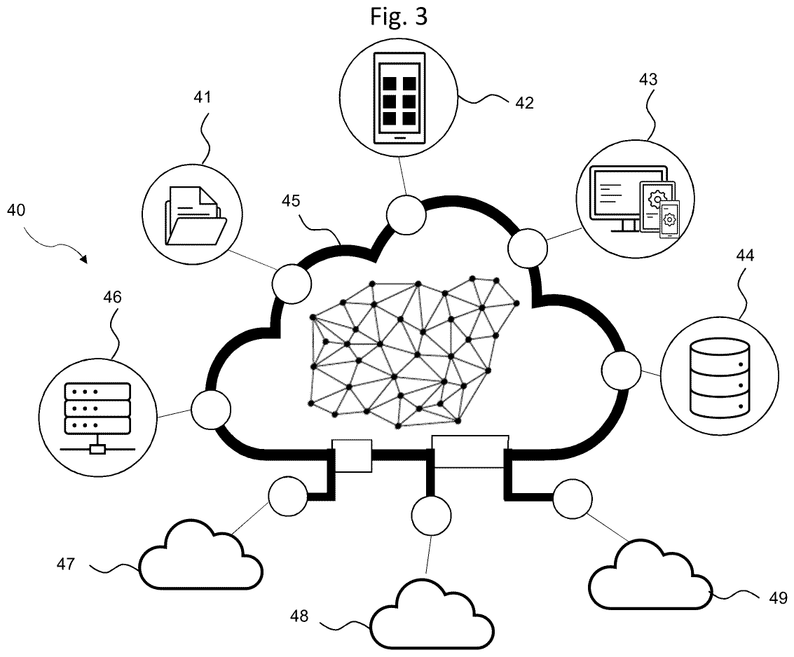

FIG. 3 illustrates an example embodiment of a distributed computing environment 40. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 40 may contain the following computing resources: mobile device(s) 42, applications 43, databases 44, data storage and server(s) 46. The cloud computing environment 40 may be deployed as public cloud 47, private cloud 48 or hybrid cloud 49. A private cloud 47 may be owned by an organization and only the members of the organization with proper access can use the private cloud 48, rendering the data in the private cloud at least confidential. In contrast, data stored in a public cloud 48 may be open to anyone over the internet. The hybrid cloud 49 may be a combination of both private and public clouds 47, 48 and may allow to keep some of the data confidential while other data may be publicly available.

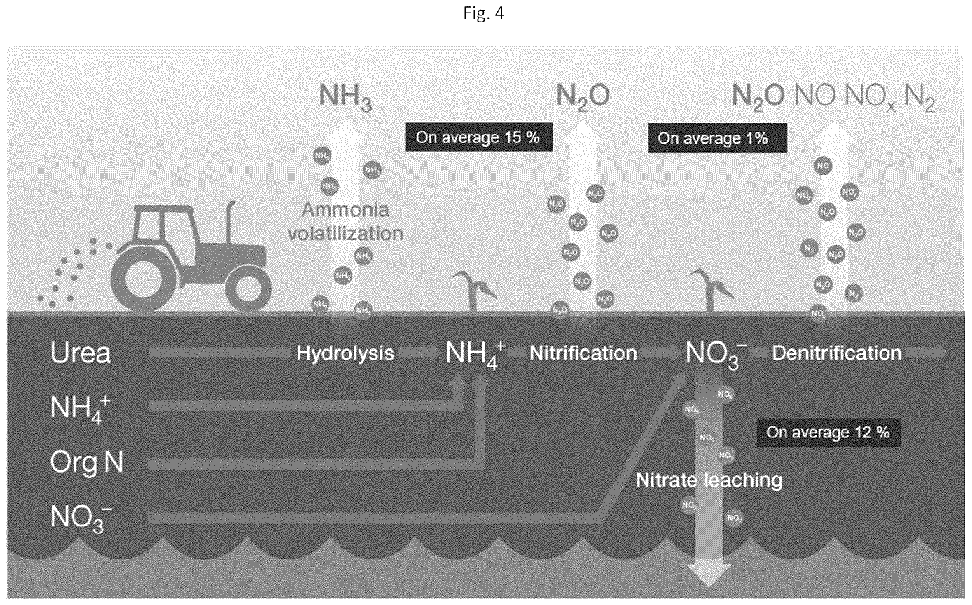

FIG. 4 schematically illustrates N loss reactions that may occur in the soil. The nitrogen (N) containing fertilizers which are applied by famers to their fields comprise different N forms: urea, ammonium, nitrate, organic N and/or combinations thereof. All these N forms are transformed in the soil in different transformations processes into other N forms (hydrolysis, mineralization, nitrification, nitrification). During these transforming process N losses in form of ammonia (NH₃), nitrous oxide (N₂O, NOₓ), elemental N (N₂) and/or nitrate (NO₃) can occur. In the red boxes average emissions factors of IPCC (2019) for these losses are mentioned. The N₂O losses from the soil due to the hydrolysis of urea, nitrification of ammonium and denitrification of nitrate are so-called direct N₂O emissions. The also emitted ammonia from the hydrolysis of urea and the nitrate from leaching process are still in the system and can be itself nitrified (in case of ammonia) and denitrified (in case of nitrate) if they come into soil again, which will result also in N₂O emissions. The kind of N₂O emissions are called indirect N₂O emissions.

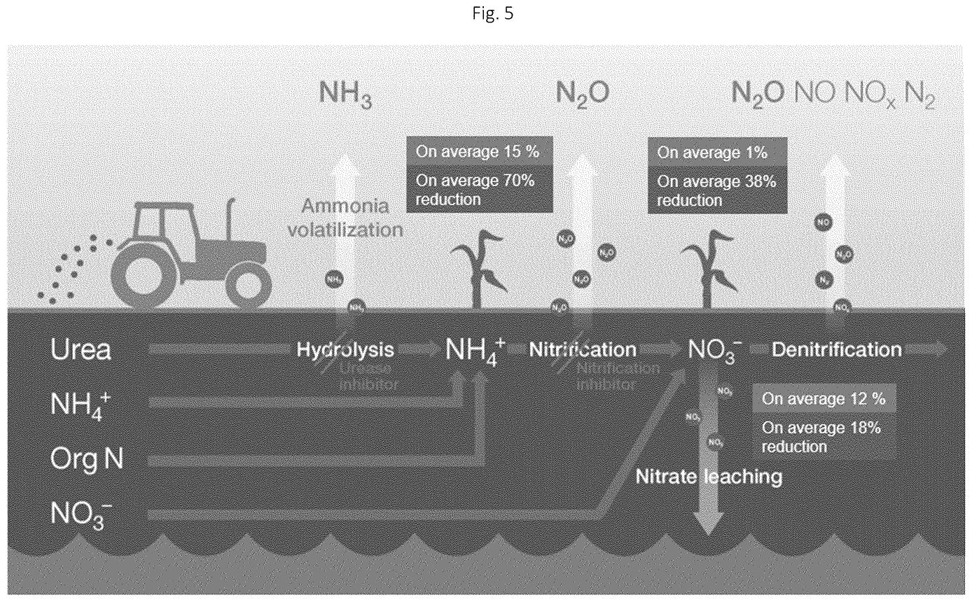

FIG. 5 schematically illustrates the effects of nitrogen inhibitors. With the application of fertilizer additives (nitrogen inhibitors, e.g. urease inhibitors and nitrification inhibitors), which are applied with/on/in the fertilizers, these losses can be significantly reduced. In the green boxes average reduction factors of FEE (2021) for these losses are mentioned.

In the following, examples of the emission calculation model are provided. In the Example 1, as first and second fertilizer products urea fertilizers are compared, wherein the first fertilizer product comprises a nitrification inhibitor as means for reducing nitrogen losses and the second fertilizer product does not comprise a nitrification inhibitor as means for reducing nitrogen losses. In the Example 2, as first and second fertilizer products urea fertilizers are compared, wherein the first fertilizer product comprises a urease inhibitor as means for reducing nitrogen losses and the second fertilizer product does not comprise a urease inhibitor as means for reducing nitrogen losses.

### Example 1

N amount: 100 kg/ha N
Type of fertilizer: urea (46% N w/w)
   Calculation of CO₂eq Emissions of Urea Fertilizer with Nitrification Inhibitor (NI)—First Fertilizer Product

### 1.1 Direct N₂O Emissions

N₂O emission factor: average 1% N₂O—N of applied N (range 0.1 to 2.9% due to different soil and climate conditions, crops and fertilizers, e.g. IPCC 2019)

N₂O emission reduction factor of a nitrification inhibitor: average minus 38% (range −31 to −44%, e.g. Akiyama et al. 2010)
N₂O emission factor for NI: 1%*(100−38) %=0.62% N₂O—N of applied N
100 kg/ha N*0.62%=0.62 kg/ha N₂O—N*1.57=0.97 kg N₂O*298 (conversion factor for N₂O into CO₂ eq, Myhre et al. 2013)=290.0 kg/ha CO₂ eq

### 1.2 Indirect N₂O Emissions:

### 1.2.1 Indirect N₂O Emissions (Due to Nitrate Leaching Losses):

NO₃ emission factor: average 12% NO₃—N of applied N (range 0 to 24% due to different climate conditions, e.g. IPCC 2019)

NO₃ emission reduction factor for NI: average minus 18% (range −7 to −29% due to different growing conditions, e.g. Quemada et al. 2013)
NO₃ emission factor for NI: 12%*(100-18) %=9.84% NO₃—N of applied N

N₂O emissions factor for N leaching: 1.1% N₂O—N of leached N (range 0 to 2% due to different growing conditions, e.g. IPCC 2019)

$$100 kg / ha N * 9.84 \% = 9.84 kg / ha {NO}_{3} - N * 1.1 \% = 0.108 kg / ha {N}_{2} O - N * 1.57 = 0.17 kg / ha {N}_{2} O * 298 = 50.6 kg / ha {CO}_{2} e q$$

1.2.2 Indirect N₂O Emissions (Due to NH₃ Emissions):

NH₃ emissions factor: average 15% NH₃—N of applied N (range 0 to 43% due to different soil and climate conditions and fertilizers, e.g. IPCC 2019)

NH₃ emission increase factor for a nitrification inhibitor on urea: average plus 47% (range +30 to +65%, e.g. Wu et al. 2021)
NH₃ emission factor for nitrification inhibitor on urea: 15*(100+47) %=22.05% NH₃—N of applied N

N₂O emission factor for NH₃ emissions: average 1% N₂O—N of emitted NH₃—N (range 0 to 1.8% depending on different growing conditions)

$$100 kg / ha N * 22.05 \% = 22.05 kg / ha {NH}_{3} - N * 1 \% = 0.22 kg / ha {N}_{2} O - N * 1.57 = 0.35 kg / ha {N}_{2} O * 298 = 103.2 kg / ha {CO}_{2} e q$$

Total CO₂ eq emissions: 290.0+50.6+103.2=443.8 kg/ha CO₂ eq if 100 kg/ha N are applied in form of urea with nitrification inhibitor.

Calculation of the CO₂eq Emissions of Urea Fertilizer without Nitrification Inhibitor—Second Fertilizer Product

### 1.1 Direct N₂O Emissions:

N₂O emission factor: average 1% N₂O—N of applied N (range 0.1 to 2.9% due to different soil and climate conditions, crops and fertilizers, e.g. IPCC 2019)
100 kg/ha N*1%=1 kg/ha N₂O—N*1.57=1.57 kg N₂O*298 (conversion factor for N₂O into CO₂ eq, Myhre et al. 2013)=467.9 kg/ha CO₂ eq

### 1.2 Indirect N₂O Emissions:

### 1.2.1 Indirect N₂O Emissions (Due to Nitrate Leaching Losses):

NO₃ emission factor: average 12% NO₃—N of applied N (range 0 to 24% due to different climate conditions, e.g. IPCC 2019)

N₂O emissions factor for N leaching: average 1.1% N₂O—N of leached N (range 0 to 2% due to different growing conditions, e.g. IPCC 2019)

$$100 kg / ha N * 12 \% = 12 kg / ha {NO}_{3} - N * 1.1 \% = 0.13 kg / ha {N}_{2} O - N * 1.57 = 20.72 kg / ha {N}_{2} O * 298 = 61.8 kg / ha {CO}_{2} e q$$

1.2.2 Indirect N₂O Emissions (Due to NH₃ Emissions):

NH₃ emissions factor: average 15% NH₃—N of applied N (range 0 to 43% due to different soil and climate conditions and fertilizers, e.g. IPCC 2019)

N₂O emission factor for NH₃ emissions: average 1% N₂O—N of emitted NH₃—N (range 0 to 1.8% depending on different growing conditions)

$$100 kg / ha N * 15 \% = 15 kg / ha {NH}_{3} - N * 1 \% = 0.15 kg / ha {N}_{2} O - N * 1.57 = 0.24 kg / ha {N}_{2} O * 298 = 70.2 kg / ha {CO}_{2} e q$$

Total CO₂ eq emissions: 467.9+61.8+70.2=600 kg/ha CO₂ eq if 100 kg/ha N are applied in form of urea without nitrification inhibitor.

### Total CO₂eq Savings:

Total CO₂eq emissions of 100 kg/ha N in form of urea without nitrification inhibitor: 600.00 kg/ha
CO₂eq
minus
Total CO₂eq emissions of 100 kg/ha N in form of urea with nitrification inhibitor: 443.80 kg/ha CO₂ eq
=156.2 kg/ha CO₂eq savings due to the use of a nitrification inhibitor

### Example 2

N amount: 100 kg/ha N
Type of fertilizer: urea (46% N w/w)
   Calculation of CO₂eq Emissions of Urea Fertilizer with Urease Inhibitor (UI)—First Fertilizer Product

### 1.1 Direct N₂O Emissions:

N₂O emission factor: average 1% N₂O—N of applied N (range 0.1 to 2.9% due to different soil and climate conditions, crops and fertilizers, e.g. IPCC 2019)

N₂O emission reduction factor of a urease inhibitor: average minus 25% (range −3 to −39% depending on different growing conditions, e.g. Cowan et al. 2020)>
N₂O emission factor for urease inhibitors: 1%*(100-25) %=0.75% N₂O—N of applied N
100 kg/ha N*0.75%=0.75 kg/ha N₂O—N*1.57=1.18 kg N₂O*298 (conversion factor for N₂O into CO₂ eq, Myhre et al. 2013)=350.9 kg/ha CO₂ eq
   1.2 Indirect N₂O Emissions (Due to NH₃ Emissions):

NH₃ emissions factor: average 15% NH₃—N of applied N (range 0 to 43% due to different soil and climate conditions and fertilizers, e.g. IPCC 2019)

NH₃ emission reduction factor for a urease inhibitor on urea: average minus 70% (Bittman et al. 2014, range 0 to −94% depending on different growing conditions, e.g. Silva et al. 2017)
NH₃ emission factor for UI on urea: 15*(100-70) %=4.5% NH₃—N of applied N

N₂O emission factor for NH₃ emissions: average 1% N₂O—N of emitted NH₃—N (range 0 to 1.8% depending on different growing conditions)

$$100 kg / ha N * 4.5 \% = 4.5 kg / ha {NH}_{3} - N * 1 \% = 0.045 kg / ha {N}_{2} O - N * 1.57 = 0.07 kg / ha {N}_{2} O * 298 = 21.1 kg / ha {CO}_{2} e q$$

Total CO₂ eq emissions: 350.9+21.1=372.0 kg/ha CO₂ eq if 100 kg/ha N are applied in form of urea with urease inhibitor.

Calculation of the CO₂Eq Emissions of Urea without Urease Inhibitor

### 1.1 Direct N₂O Emissions:

N₂O emission factor: average 1% N₂O—N of applied N (range 0.1 to 2.9% due to different soil and climate conditions, crops and fertilizers, e.g. IPCC 2019)
100 kg/ha N*1%=1 kg/ha N₂O—N*1.57=1.57 kg N₂O*298 (conversion factor for N₂O into CO₂ eq, Myhre et al. 2013)=467.9 kg/ha CO₂ eq
   1.2 Indirect N₂O Emissions (Due to NH₃ Emissions):

NH₃ emissions factor: average 15% NH₃—N of applied N (range 0 to 43% due to different soil and climate conditions and fertilizers, e.g. IPCC 2019)

N₂O emission factor for NH₃ emissions: average 1% N₂O—N of emitted NH₃—N (range 0 to 1.8% depending on different growing conditions)

$$100 kg / ha N * 15 \% = 15 kg / ha {NH}_{3} - N * 1 \% = 0.15 kg / ha {N}_{2} O - N * 1.57 = 0.24 kg / ha {N}_{2} O * 298 = 70.2 kg / ha {CO}_{2} e q$$

Total CO₂ eq emissions: 467.9+70.2=538.10 kg/ha CO₂ eq if 100 kg/ha N are applied in form of urea without urease inhibitor.

### Total CO₂Eq Savings:

Total CO₂ eq emissions of 100 kg/ha N in form of urea without urease inhibitor: 538.10 kg/ha CO₂ eq
minus
Total CO₂ eq emissions of 100 kg/ha N in form of urea with urease inhibitor: 372.00 kg/ha CO₂ eq=166.1 kg/ha CO₂ eq savings due to the use of an urease inhibitor

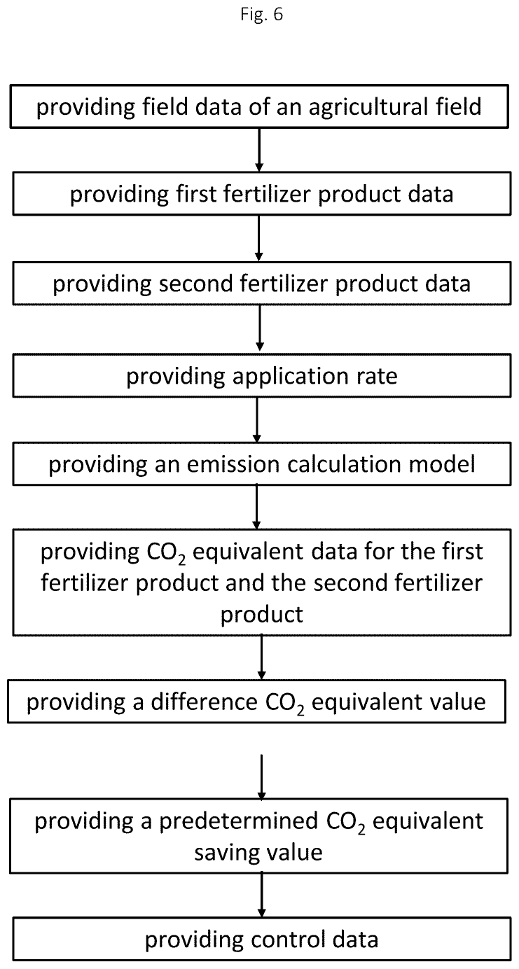

FIG. 6 illustrates a computer-implemented method for providing control data for an application device for applying a fertilizer product on an agricultural field. In a first step, field data of an agricultural field are provided. In a further step, first fertilizer product data, wherein the first fertilizer product data relates to a nitrogen fertilizer product comprising means for reducing nitrogen losses, are provided. In a next step, second fertilizer product data, wherein the second fertilizer product data relates to a nitrogen fertilizer product not comprising means for reducing nitrogen losses, are provided. Subsequently, application rate data for the first fertilizer product and the second fertilizer product comprising application rates for applying the first fertilizer product and the second fertilizer product on the agricultural field based on the provided field data, are provided. As next step, an emission calculation model configured to calculate CO₂ equivalents for the first fertilizer product and the second fertilizer product based on the first fertilizer product data and the second fertilizer product data and the application rate data for the first fertilizer product and the second fertilizer product, is provided. Then, CO₂ equivalent data for the first fertilizer product and the second fertilizer product utilizing the emission calculation model are provided, for example, as exemplified above in Examples 1 and 2. Based on these CO₂ equivalent data, a difference CO₂ equivalent value between an application of the first fertilizer product and the second fertilizer product based on the CO₂ equivalent data, as also exemplified above in Examples 1 and 2. A CO₂ equivalent saving value may be provided, e.g. as target value by a farmer. Finally, based on the saving value, an objective decision can be made as to whether a particular field should be applied with the first or the second fertilizer product, and thus whether the use of means for reducing nitrogen losses is objectively justified.

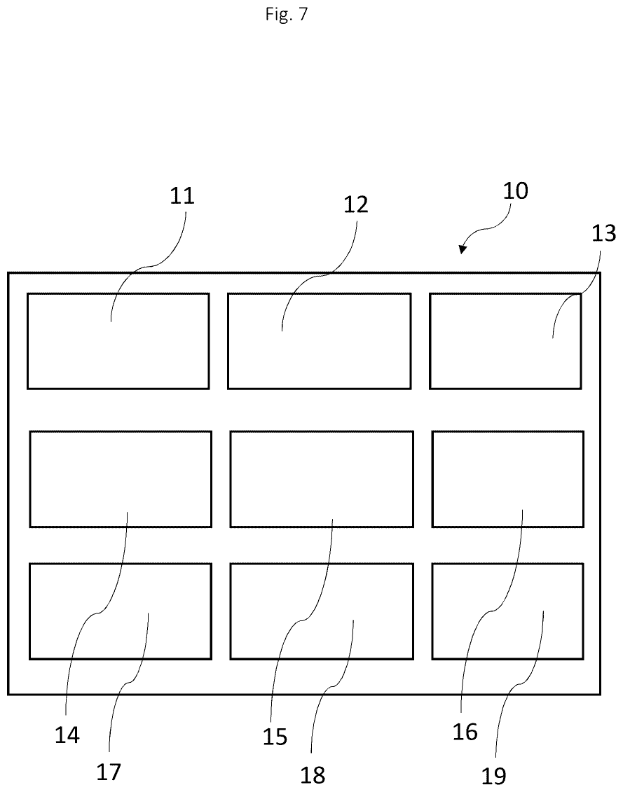

FIG. 7 illustrates a system 10 for providing control data for an application device for applying a fertilizer product on an agricultural field. The system comprises a providing unit 11 configured to provide field data of an agricultural field, a further providing unit 12 configured to provide first fertilizer product data, wherein the first fertilizer product data relates to a nitrogen fertilizer product comprising means for reducing nitrogen losses, a further providing unit 13 configured to provide second fertilizer product data, wherein the second fertilizer product data relates to a nitrogen fertilizer product not comprising means for reducing nitrogen losses, a further providing unit 14 configured to provide application rate data for the first fertilizer product and the second fertilizer product comprising application rates for applying the first fertilizer product and the second fertilizer product on the agricultural field based on the field data, a further providing unit 15 configured to provide an emission calculation model configured to calculate CO₂ equivalents for the first fertilizer product and the second fertilizer product based on the first fertilizer product data and the second fertilizer product data and the application rate data for the first fertilizer product and the second fertilizer product, a further providing unit 16 configured to provide CO₂ equivalent data for the first fertilizer product and the second fertilizer product utilizing the emission calculation model, a further providing unit 17 configured to provide a difference CO₂ equivalent value between an application of the first fertilizer product and the second fertilizer product based on the CO₂ equivalent data, a further providing unit 18 configured to provide a predetermined CO₂ equivalent saving value, a further providing unit 19 configured, in case the difference CO₂ equivalent value is above or equal to the CO₂ equivalent saving value, to provide control data for an application device for applying the first fertilizer product on the agricultural field; and in case the difference CO₂ equivalent value is below the CO₂ equivalent saving value to provide control data for an application device for applying the second fertilizer product on the agricultural field.

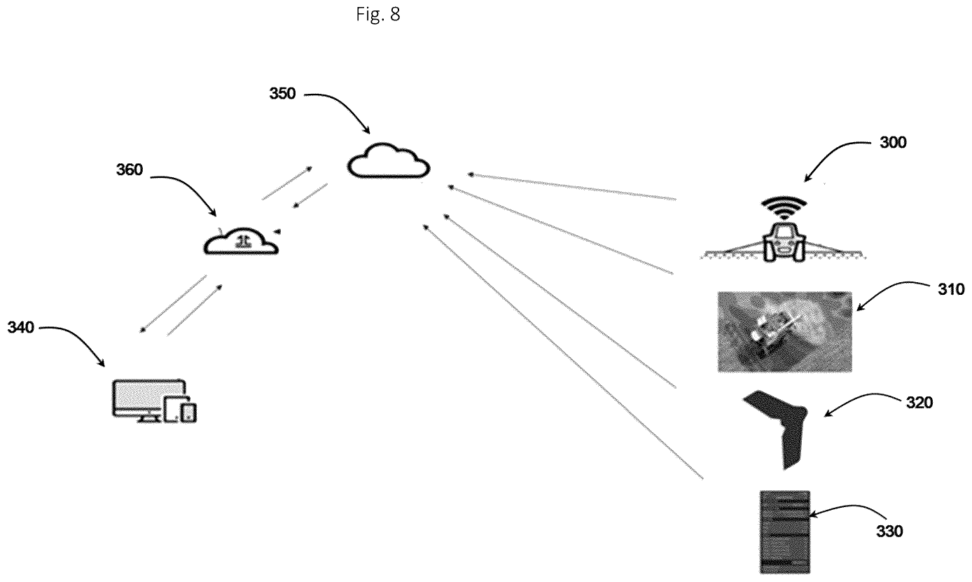

FIG. 8 illustrates exemplarily the different possibilities to receive and process field data. For example, field data can be obtained by all kinds of agricultural equipment 300 (e.g. a tractor 300) as so-called as-applied maps by recording the application rate at the time of application. It is also possible that such agricultural equipment comprises sensors (e.g. optical sensors, cameras, infrared sensors, soil sensors, etc.) to provide, for example, a fertilizer/nitrogen distribution map. It is also possible that during harvesting the yield (e.g. in the form of biomass) is recorded by a harvesting vehicle 310. Furthermore, corresponding maps/data can be provided by land-based and/or airborne drones 320 by taking images of the field or a part of it. Finally, it is also possible that a geo-referenced visual assessment 330 is performed and that this field data is also processed. Field data collected in this way can then be merged in a computing device 340, where the data can be transmitted and computed, for example, via any wireless link, cloud applications 350 and/or working platforms 360, wherein the field data may also be processed in whole or in part in the cloud application 350 and/or in the working platform 360 (e.g., by cloud computing).

Aspects of the present disclosure relates to computer program elements configured to carry out steps of the methods described above. The computer program element might therefore be stored on a computing unit of a computing device, which might also be part of an embodiment. This computing unit may be configured to perform or induce performing of the steps of the method described above. Moreover, it may be configured to operate the components of the above described system. The computing unit can be configured to operate automatically and/or to execute the orders of a user. The computing unit may include a data processor. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfill the procedure of an exemplary embodiment of the method as described above. According to a further exemplary embodiment of the present disclosure, a computer readable medium, such as a CD-ROM, USB stick, a downloadable executable or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, any steps presented, e.g. cf. method mentioned page 6, can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for providing control data for an application device for applying a fertilizer product on an agricultural field, comprising:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value; and
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

2. The computer-implemented method according to claim 1, wherein the means for reducing nitrogen losses are provided by a nitrogen inhibitor, a biological product increasing the efficacy of nitrogen utilization, a slow release fertilizer and/or a controlled release fertilizer.

3. The computer-implemented method according to claim 1, wherein the emission calculation model is configured to calculate CO₂ equivalents based on the amount of nitrogen in the fertilizer products and the application rates.

4. The computer-implemented method according to claim 1, wherein the emission calculation model is configured to calculate direct N₂O emissions, indirect N₂O emissions due to NO₃ leaching/losses and/or indirect N₂O emissions due to NH₃ losses caused by the applied nitrogen amount of the fertilizers with and without nitrogen inhibitor.

5. The computer-implemented method according to claim 1, wherein the emission calculation model is configured to calculate direct N₂O emissions of the first fertilizer product based on a N₂O reduction factor compared to N₂O emissions of the second fertilizer product.

6. The computer-implemented method according to claim 5, wherein for different first fertilizer products different N₂O reduction factors are provided.

7. The computer-implemented method according to claim 5, wherein for different climate conditions and/or weather conditions and/or soil conditions/parameters and/or farm management factors different N₂O reduction factors are provided.

8. The computer-implemented method according to claim 1, wherein the emission calculation model is configured to calculate indirect N₂O emissions due to NO₃ leaching of the first fertilizer product based on a NO₃ reduction factor compared to NO₃ emissions of the second fertilizer product.

9. The computer-implemented method according to claim 8, wherein for different first fertilizer products different NO₃ reduction factors are provided; and/or wherein for different climate conditions and/or weather conditions and/or soil conditions/parameters and/or farm management factors different NO₃ reduction factors are provided.

10. The computer-implemented method according to claim 1, wherein the emission calculation model is configured to calculate indirect N₂O emissions due to NH₃ losses caused by the nitrogen inhibitor based on a NH₃ reduction or increase factor compared to NH₃ emissions of the second fertilizer product.

11. The computer-implemented method according to claim 5, wherein different reduction and increase factors are provided for different fertilizing products and/or climate conditions and/or weather conditions and/or soil conditions/parameters and/or farm management factors different reduction and increase factors are provided.

12. An application device for applying a fertilizer product on an agricultural field, wherein control data for the application device are provided by the method according to claim 1.

13. An apparatus for providing control data for an application device for applying a fertilizer product on an agricultural field, the apparatus comprising: one or more computing nodes; and one or more computer-readable media having thereon computer-executable instructions that are structured such that, when executed by the one or more computing nodes, cause the apparatus to perform the following steps:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the field data;
providing an emission calculation model configured to calculate CO₂ equivalents for the first fertilizer product and the second fertilizer product based on the first fertilizer product data and the second fertilizer product data and the application rate data for the first fertilizer product and the second fertilizer product;
providing CO₂ equivalent data for the first fertilizer product and the second fertilizer product utilizing the emission calculation model;
providing a difference CO₂ equivalent value between an application of the first fertilizer product and the second fertilizer product based on the CO₂ equivalent data;
providing a predetermined CO₂ equivalent saving value; and
in case the difference CO₂ equivalent value is above or equal to the CO₂ equivalent saving value providing control data for an application device for applying the first fertilizer product on the agricultural field; and in case the difference CO₂ equivalent value is below the CO₂ equivalent saving value providing control data for an application device for applying the second fertilizer product on the agricultural field.

14. (canceled)

15. A computer program element with instructions, which, when executed on computing devices of a computing environment, is configured to carry out the steps of the computer-implemented method according to claim 1.

16. A computer-implemented method for providing CO2 equivalent data for fertilizer products for an agricultural field, comprising:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO2 equivalents for the first fertilizer product and the second fertilizer product based on the first fertilizer product data and the second fertilizer product data and the application rate data for the first fertilizer product and the second fertilizer product; and
providing CO2 equivalent data for the first fertilizer product and the second fertilizer product utilizing the emission calculation model.

17. A system for providing CO2 equivalent data for fertilizer products for an agricultural field, comprising:
a providing unit configured to provide field data of an agricultural field;
a further providing unit configured to provide first fertilizer product data, wherein the first fertilizer product data relates to a nitrogen fertilizer product comprising means for reducing nitrogen losses;
a further providing unit configured to provide second fertilizer product data, wherein the second fertilizer product data relates to a nitrogen fertilizer product not comprising means for reducing nitrogen losses;
a further providing unit configured to provide application rate data for the first fertilizer product and the second fertilizer product comprising application rates for applying the first fertilizer product and the second fertilizer product on the agricultural field based on the provided field data;
a further providing unit configured to provide an emission calculation model configured to calculate CO2 equivalents for the first fertilizer product and the second fertilizer product based on the first fertilizer product data and the second fertilizer product data and the application rate data for the first fertilizer product and the second fertilizer product; and
a further providing unit configured to provide CO2 equivalent data for the first fertilizer product and the second fertilizer product utilizing the emission calculation model.

18. An apparatus for providing CO2 equivalent data for fertilizer products for an agricultural field, the apparatus comprising: one or more computing nodes; and one or more computer-readable media having thereon computer-executable instructions that are structured such that, when executed by the one or more computing nodes, cause the apparatus to perform the following steps:
providing field data of an agricultural field;
providing first fertilizer product data, wherein the first fertilizer product data relates to a nitrogen fertilizer product comprising means for reducing nitrogen losses;
providing second fertilizer product data, wherein the second fertilizer product data relates to a nitrogen fertilizer product not comprising means for reducing nitrogen losses;
providing application rate data for the first fertilizer product and the second fertilizer product comprising application rates for applying the first fertilizer product and the second fertilizer product on the agricultural field based on the provided field data;
providing an emission calculation model configured to calculate CO2 equivalents for the first fertilizer product and the second fertilizer product based on the first fertilizer product data and the second fertilizer product data and the application rate data for the first fertilizer product and the second fertilizer product; and
providing CO2 equivalent data for the first fertilizer product and the second fertilizer product utilizing the emission calculation model.

19. A computer program element with instructions, which, when executed on computing devices of a computing environment, is configured to carry out the steps of the computer-implemented method for providing CO2 equivalent data for fertilizer products for an agricultural field according to claim 16.

20. A computer-implemented method for providing CO2 equivalent data for a fertilizer product for an agricultural field, comprising:
providing field data of an agricultural field;
providing fertilizer product data, wherein the fertilizer product data relates to a nitrogen fertilizer product comprising means for reducing nitrogen losses;
providing application rate data for the fertilizer product comprising application rates for applying the fertilizer product on the agricultural field based on the provided field data;
applying the fertilizer product on the agricultural field based on the application rate data;
providing an emission calculation model configured to calculate CO2 equivalents for the fertilizer product based on the fertilizer product data and the application rate data for the fertilizer product;
providing CO2 equivalent data for the fertilizer product utilizing the emission calculation model; and
optionally, providing the CO2 equivalent data to a measurement, reporting and verification (MRV) system.

21. (canceled)

22. (canceled)

23. A computer program element with instructions, which, when executed on computing devices of a computing environment, is configured to carry out the steps of the computer-implemented method according to claim 16.
